(19) United States
(12) Patent Application Publication
(10) Pub. No.: US 2007/0136397 A1
(43) Pub. Date: Jun. 14, 2007

(54) Information life-cycle management architecture for a device with infinite storage capacity

(75) Inventors: Ravikumar V. Pragada, Collegeville, PA (US); Debashish Purkayastha, Pottstown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/321,415

(22) Filed: Dec. 29, 2005

Related U.S. Application Data
(60) Provisional application No. 60/749,238, filed on Dec. 9, 2005.

(51) Int. Cl. G06F 17/30

(52) U.S. Cl. 707/204

(57) ABSTRACT

A system for information life-cycle management includes a metadata depicter, a policy manager, a data manager, and a data organizer. The metadata depicter is configured to create metadata for an attribute of a data type. The policy manager is configured to apply the metadata as a rule to data records of the data type. The data manager is configured to control at least one data storage device, and operates under the direction of the policy manager. The data organizer is configured to determine how data is organized on the storage devices, and operates under the direction of the policy manager.

### CROSS REFERENCE TO RELATED APPLICATION

This application claims the benefit of U.S. Provisional Application No. 60/749,238, filed on Dec. 9, 2005, which is incorporated by reference as if fully set forth herein.

### FIELD OF INVENTION

The present invention generally relates to information life-cycle management (ILM), and more particularly, to an ILM architecture for devices with infinite storage capacity.

### BACKGROUND

Albeit varying substantially in definition from vendor to vendor, ILM is essentially defined as providing a single view of all information resources spanning all types of platforms which align the stored data based on the value provided to the business needs at any point of time.

Current ILM architectures cater more towards storage infrastructure. For example, FIG. 1 shows an embodiment of an existing ILM architecture 100. The architecture 100 includes a plurality of servers 102, one or more local storage devices 104, and backup devices 106. The backup devices 106 can include, for example, a disk-based storage device 108 and a tape drive 110. An ILM server 112 is located between the local storage devices 104 and the backup devices 106. There are several data paths between the servers 102 and the backup devices 106. One path is directly from the servers 102 to the backup devices 106 (path 120). A second path is from the local storage devices 104 to the backup devices 106 (path 122). A third path is via the ILM server 112.

The main emphasis of existing ILM architectures is placed on how different forms of storage media can be used optimally in order to reduce costs. Current ILM architectures define ILM as a way to reduce the costs associated with storing all information on high-availability storage systems such as disk. The critical questions the architecture addresses are: what kind of data should be moved towards cheaper forms of media, and when would it make sense to move the data towards cheaper forms of media?

Current ILM strategies only provide a way to align the cost of storage with the value of information, and not towards a device with infinite storage capacity, let alone the battery consumption of a mobile device with infinite storage. There are no existing ILM architectures that cater towards a storage device with infinite storage capacity.

U.S. patent application Publication No. 2005/0033757 relates to data and storage management based on policies. The operations to be performed are automatically determined based upon policies configured for the data and storage environment. Files on which the selected operation is to be performed are also automatically determined. The files may be selected using different techniques based upon characteristics of the files and the operation to be performed. Target storage units, if needed for the operation, are also automatically determined. Examples of policy-driven operations to be performed on the selected files include copying, moving, deleting, archiving, making a backup, restoring, migrating, and recalling.

U.S. patent application Publication No. 2005/0055211 relates to a method to monitor, record, archive, index, retrieve, and perform processing of archived and live communications, in particular as applied to a Voice over Internet Protocol (VoIP) network conveying telephone calls. The method includes receiving VoIP data from the network representing the telephone call and the control elements of the connection. A series of processes are performed on the data to monitor its content, record the data, archive the recorded data, index the content of the call, retrieve the recorded data from the archive, and control the progress of the data traffic that supports the telephone call (e.g., terminate a call if a non-compliant conversation is taking place or if communication with an unauthorized person or entity is attempted). The method uses network data-to-text processing to identify key words or phrases and/or to convert the entire data set/traffic representing telephone conversations into text.

U.S. Patent Application Publication No. 2005/0138081 describes a method for reducing information latency in a business enterprise. The method includes accessing a data source and obtaining transaction information relating to changes in the data source. The data source contains data instances and metadata. A change in either a data instance or metadata may activate an event. A determination is made whether a response to an event initiated by a change in the data source is necessary. This determination also includes discerning whether the change in the data source was made by an application or was external to an application.

At its core, the process of ILM moves data up and down a path of tiered storage resources, including high performance, high-capacity disk arrays; lower-cost disk arrays such as serial ATA (SATA); tape libraries; and permanent archival media. ILM also encompasses scheduled data deletion and regulatory compliance for data retention as well. Because decisions about moving, deleting, and retaining data are closely tied to application use of data, ILM solutions are usually closely tied to applications.

In one implementation, ILM solutions can be grouped into five categories:

(1) E-mail archive, which addresses one of the fastest-growing storage components for many companies. Solutions are designed to reduce the size of corporate e-mail systems by moving e-mail attachments and/or messages to an archive from which they can easily be recovered if needed.

(2) Application and database archive. Similar in concept to an e-mail archive, but instead deals with the growth of information in corporate databases such as ERP systems. It is designed to identify database data that is no longer being regularly accessed and to move that data to an archive where it remains available, if needed.

(3) Data life-cycle management, which provides movement of files up and down a tiered storage hierarchy based on factors such as age and size of data.

(4) Content management can be part of any ILM solution, and is designed to manage all types of information (database, e-mail, documents, images, etc.) within a common repository. By having related information in a single location, the information is easy to locate and protect.

(5) Retention management also can be a part of any ILM solution, and is frequently part of a content management system. Retention management helps an ILM solution protect information from deletion and also helps enable deletion of information that is no longer needed.

In general, the ILM process can be broken into five phases.

(1) Data discovery and classification, which includes creating an inventory of enterprise data. A user can decide where the data should be located based on its relevance.

(2) Putting storage tiers into place, to help assure that data is stored on the appropriate storage tier based on the performance, availability, retention, and cost requirements of the information.

(3) Data movement by policy, including automatic, policy-based migration to move data from online storage to tiered storage data archives. Data replication both improves the quality of services and reduces cost.

(4) Continuous information availability. It is essential to have continuous long-term access to data, with or without the application that originally created it. Some ILM solutions enable a user to normalize context indexing and search functionality while protecting and optimizing stored data. In addition, ILM can also enable the user to exploit continuous data protection and disk-to-disk backup technologies to provide file and database protection.

(5) Application-aware solutions relate to information challenges around rapidly expanding databases, the overwhelming flood of e-mail, and the need to protect application information. Application-aware ILM solutions can support the archiving and management needs of business-critical applications such as e-mail and messaging, databases, ERP, CRM, medical imaging, etc.

Existing ILM architectures focus more on what kind of media device (disk, tape, etc.) to store data, and not on how to organize the data for efficient retrieval. Existing ILM architectures only consider access security and do not stress changing security requirements of data. Security requirements of data change over time, and this situation needs to be addressed as part of the ILM architecture.

For a device with infinite storage capacity, obtaining data and data synchronization are major issues. Even though this is a crucial part of ILM, current ILM architectures lack this fundamental piece. Backup requirements vary substantially for a device with infinite storage as compared to back-up requirements for an enterprise. Battery consumption and how and when data will be backed up are some of the issues that also need to be addressed.

The problems associated with a portable device with infinite storage capacity include: limited MIPS; limited battery power; limited user interface for data management; limited bandwidth with an on/off nature; security risk (a portable device is prone to theft and loss); a user's device acting as a data store behaves as a client and needs to maintain the freshness of data; unintentional data loss due to a limited user interface and carelessness on the user's part; flexibility in ILM for an individual user; and inefficient data retrieval due to the unstructured nature of the data and no existing relationships between associated data records.

### SUMMARY

The present invention proposes a new ILM architecture for portable devices which guarantees data synchronization, enhances data security and retrieval with limited bandwidth, minimizes power consumption, and reduces computational complexity. This architecture emphasizes how information is managed throughout its life-cycle, from obtaining data to its removal along with its security aspects. User preferences drive metadata representation, which in turn drives information storage and retrieval, data synchronization, and security aspects.

The present invention provides the several advantages, including: reduced battery consumption by providing efficient data retrieval; accounting for the on/off nature of the mobile channel while synchronizing and obtaining data; flexibility in defining rules and policies for information management; rules for metadata that are driven at a user level to provide flexibility; and extensible metadata rules such that new rules can be easily defined for evolving requirements.

A system for information life-cycle management includes a metadata depicter, a policy manager, a data manager, and a data organizer. The metadata depicter is configured to create metadata for an attribute of a data type. The policy manager is configured to apply the metadata as a rule to data records of the data type. The data manager is configured to control at least one data storage device, and operates under the direction of the policy manager. The data organizer is configured to determine how data is organized on the storage devices, and operates under the direction of the policy manager.

A self-learning policy manager for use in a information life-cycle management system includes a policy driver, a statistics collector, and a metadata classifier. The policy driver is configured to apply a rule to a data record based on predefined metadata. The statistics collector is configured to collect statistics about the applied rule. The metadata classifier is configured to determine whether the rule needs to be revised based on the collected statistics.

A method for information life-cycle management begins by defining metadata attributes for a data type. A rule is created based on the metadata attributes and is applied to data records. Application of the rule is recorded and statistics are collected about the application of the rule. A determination is made whether the rule needs to be revised based on the collected statistics. The rule is revised if needed and metadata associated with the rule is updated.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a diagram of an existing ILM architecture;

FIG. 2 is a block diagram of an ILM architecture for a device with infinite storage capacity;

FIG. 3 is a block diagram of a self-learning policy manager used in connection with the ILM architecture shown in FIG. 2; and

FIG. 4 is a flowchart of a method for self-learning ILM.

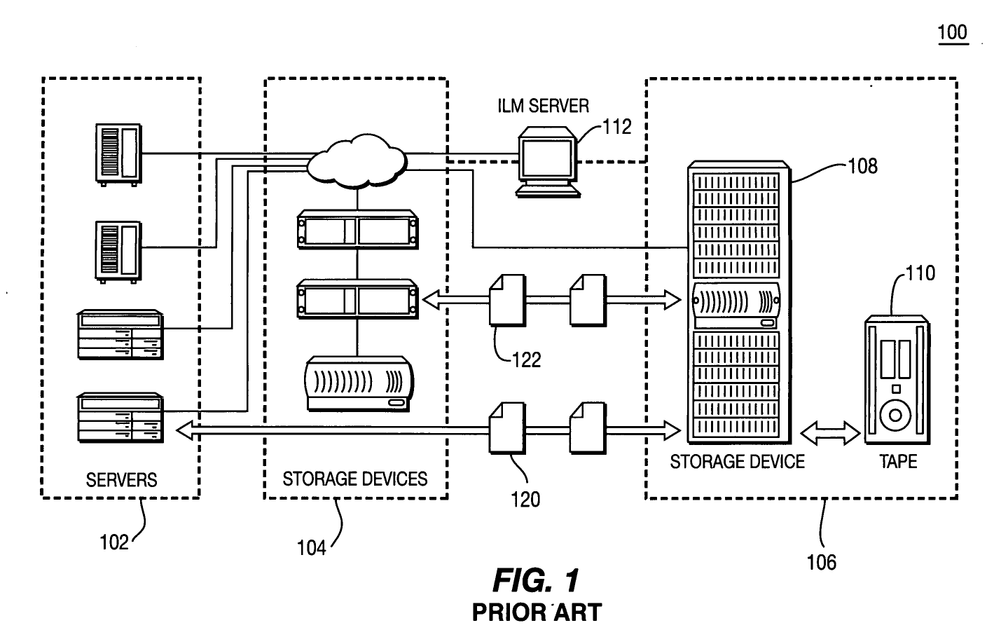

### DETAILED DESCRIPTION OF THE PREFERRED EMBODIMENTS

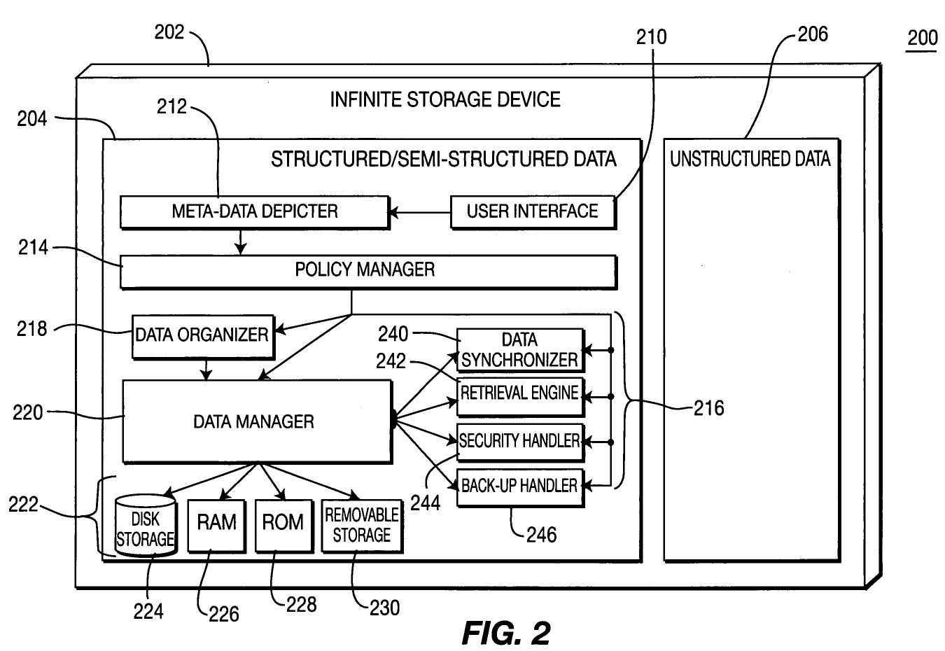

FIG. 2 is a block diagram of an ILM architecture 200 for an infinite storage device 202. The storage device 202 includes a partition for structured and semi-structured data 204 and a partition for unstructured data 206. The ILM architecture 200 is applicable only to structured and semi-structured data. Unstructured data is outside the scope of this invention, and is included here only for the sake of completeness.

A user interface 210 is responsible for obtaining user inputs. A metadata depicter 212 receives inputs from the user interface 210 and converts the inputs to metadata for a currently selected data record. A policy manager 214 receives the metadata, applies pre-defined rules for each attribute of a data record, and converts the metadata into requirements for a data handling module 216. A data organizer 218 receives instructions from the policy manager 214 to determine how the data is organized.

A data manager 220 receives the organization information from the data organizer 218 and directs the data to one of a plurality of storage devices 222. The storage devices 222 can include, but are not limited to, a disk storage 224, a random access memory (RAM) 226, a read-only memory (ROM) 228, and a removable storage device 230. The data handling modules 216 can include, but are not limited to, a data synchronizer 240, a retrieval engine 242, a security handler 244, and a backup handler 246.

The user interface 210 permits a user to specify attributes such as data category, response time, data synchronization needs, retention needs, security needs, access needs, backup requirements, data association and disposal needs, etc. If there are pre-existing user-defined attributes, these are also presented via the user interface 210 for selection as appropriate for the current data record that is being created.

The metadata depicter 212 maintains the metadata in an object oriented fashion, through which the user can extend the metadata used to describe a data record. Abstract data types can be provided to force the user to provide at least the basic information needed to maintain the structured data.

The policy manager 214 provides a broad range of functions. For instance, based on data synchronization needs, the policy manager 214 determines how frequently a particular data record has to be synchronized with the source or where and how data has to be stored and accessed in order to provide a required security level.

For ILM to work effectively, policy management is critical. In existing ILM frameworks, policies (and in turn, rules for metadata) are driven more at an enterprise level rather than at a user level. In order to be able to truly apply ILM for an infinite storage device, flexibility has to be given to the user to extend and update the policies. As more new types of data (as identified by a change in metadata requirements) start to be stored in an infinite storage device, new policies need to be identified for these new data types.

Treating each data record individually is impractical, since the number of associated policy implementations would be unmanageable. Each data record created is classified according to specific metadata attributes, which can then be either extended or new attributes be added by the user.

For each metadata attribute, certain classes or levels are defined. For example, high, medium, and low for a “backup needs” attribute. The actual values for the attribute may be defined by the system administrator to indicate high=1 hour, medium=1 day, low=1 week. However, these values will probably not always be correct for all data records. For a record with a high level set for backup, there might not be any changes to the record every hour, and trying to perform a backup every hour would waste CPU time and battery power. On the other hand, there might be a need for an hourly backup of a record which has a medium level backup setting.

As the number of metadata attributes increase in the case of an infinite storage device, this issue becomes more prominent. The policy manager 214 is self-learning and is capable of handling an increasing amount of metadata attributes and associated policies. The policy manager 214 keeps track of past events and learns over time what kind of values best suit what kinds of attributes. The policy manager 214 fine-tunes the values for each attribute category and also either increases or decreases the number of categories for each attribute automatically. This functionality improves ILM policy management of an infinite storage device.

Even though the required number of levels or classes for each existing or newly created metadata attribute may not be known, the policy manager 214 learns as events occur, and attempts to fine-tune the number of levels and their associated values. Since space is not an issue in an infinite storage device, this approach can take advantage of the available storage space and keeps track of past events. This approach reduces the burden of policy management and the need to have prior knowledge of each metadata attribute that is created.

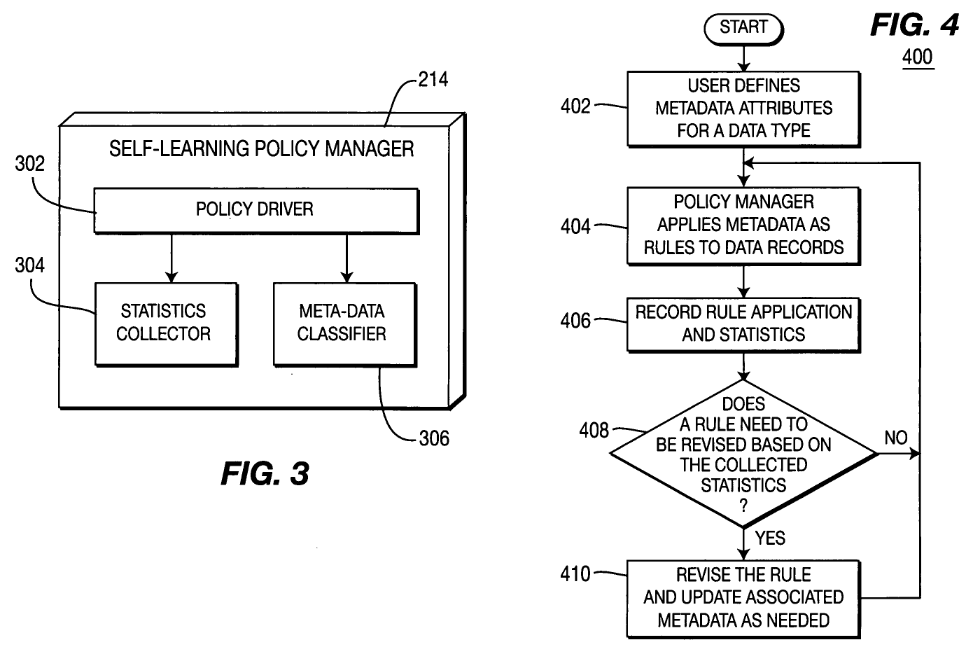

The policy manager 214 is shown in detail in FIG. 3 and includes a policy driver 302, a statistics collector 304, and a metadata classifier 306. The policy driver 302 is responsible for taking the metadata, applying the pre-defined rules for each attribute of a record, and converting the metadata into requirements for each data handling module 216. The statistics collector 304 collects information about each policy that has been enforced. It receives input from the policy driver 302 whenever an event (i.e., policy enforcement) has occurred.

The metadata classifier 306 processes the information collected by the statistics collector 304. It determines the value of each class or level for every metadata attribute and fine-tunes these values based on the new information obtained. It also determines if more classes or levels need to be defined for a particular metadata attribute and updates these accordingly. The metadata classifier 306 informs the policy driver 302 whenever it has new updates.

Referring back to FIG. 2, the data organizer 218 determines how data is organized; in other words, what kind of data association is needed for each record. These needs are dictated by the policy manager 214 and are based on the metadata input provided by the user.

In order to speed up searching and to promote efficient data retrieval, all records are stored as part of an Object-Relational Data Base Management System (ORDBMS). It is noted that other storage options for the data may be used (such as simple text, a relational database structure, an object-oriented structure, or XML-tagged data), but that the object-relational data structure described herein is efficient for the purposes of the present invention. The object-relational database contains the same data as stored in a relational database and also accommodates more complex data. For example, an individual's complete insurance record, including insurance policies, claim forms, credit card receipts, and photos of automobile collision damage can be stored as an object, providing a view of data that approximates the traditional paper record.

The ORDBMS integrates database capabilities directly into an object-oriented programming language (e.g., C++, Smalltalk, Java). This is different than a language such as SQL, which defines, retrieves, and manipulates data. ORDBMS allows for better control of complex data and complex interrelationships among objects.

Each record is an object and has its relationships defined with other records. For example, consider the financial statements of a user. They can be classified on a yearly, monthly, or weekly basis. A user might wish to view all his financial statements for a certain month. There can also be several categories of financial statements such as credit card statements, bank statements, insurance statements, utility bills, etc. The user might wish to see any of these categories at a particular instant. With the data organized as part of an ORDBMS, the data retrieval is accelerated. The drawback of ORDBMS is that it uses a large amount of memory to store all the complex data relationships. However, in an infinite storage device, this is not an issue.

The data manager 220 is the main module responsible for when, where, and how data is managed and maintained. The requirements for the data manager 220 are dictated by the policy manager 214. The data manager 220 interfaces with different kinds of physical storage devices 222 and satisfies the needs of the data handling modules 216.

The data synchronizer 240 is responsible for obtaining data and for maintaining synchronization with a data source that resides on a separate entity (either on a server or a different infinite storage device). The data synchronizer 240 is missing from current ILM architectures, and for an infinite storage device (especially a mobile device), the functions of the data synchronizer 240 are important.

The data synchronizer 240 is also responsible for handling the on/off nature of the mobile link. In order to support large file downloads over bandwidth-limited carriers, this becomes an issue. The infinite storage device must be capable of continuing a download from where it left off after an interruption, and should not be required to restart the download. This is also a problem with broadband connections, because of weaker links in the Internet and current TCP limitations.

Once data is obtained, ensuring that the data is also in sync with the data source is another important part of ILM. Any updates either on the infinite storage device or the source device have to be propagated to the peer in order to avoid problems with stale data. The SyncML language may be used in these circumstances, but any suitable synchronization protocol is acceptable.

The retrieval engine 242 retrieves data from the storage devices 222 via the data manager 220. As described above, the data organizer 218 optimizes the way data should be stored so that it can be retrieved efficiently in the future and generates metadata describing the data organization. The retrieval engine 242 reads the metadata and retrieves data efficiently since it knows how the data is organized. Existing ILM architectures do not focus on how to store data on a device so that retrieval is efficient. The storage method chosen can assist in reducing MIPS and battery consumption. The metadata chosen to represent each record also plays a role in retrieval of a given record, and flexibility needs to be provided to the user for choosing metadata in order to make information retrieval more efficient.

The security handler 244 controls access restrictions to data. Based on the security classification provided by the user, the metadata depicter 212 generates metadata to be used by the security handler 244. The security handler 244 identifies the sensitive data and the location where the data has to be stored. The location is important because some storage areas are perceived to be more secure. For example, a trust zone may be defined, which provides a secure area for storing sensitive data. Security is also an important aspect of an ILM architecture, even though it is not given much thought in existing architectures. Data that needs high security today might be publicly available at a later date. As information passes through its life-cycle, security for that information might have to be upgraded or downgraded. Highly secure data might have to be stored in a secure part of the device and access restrictions have to apply when and where this data is accessed and manipulated.

The backup handler 246 directs data backups and uses the data manager 220 to move data to an appropriate location in the data storage hierarchy. The backup handler 246 identifies three items: the data which needs to be backed up, the frequency of backup, and the location of the storage device 222 where the data should be backed up. Depending on these parameters, the backup handler 246 will backup data at the specified frequency and in the specified location. How frequently data needs to be backed up depends on the metadata requirements, as dictated by the policy manager 214. For instance, business-critical data needs to be backed up frequently, whereas reference data need not be backed up regularly. For example, there might be records that the user wants to be backed up only when connected to an external power source. For certain other critical records, these records might have to be backed up every hour (when updates are made actively), even if the device is running on a battery.

FIG. 4 is a flowchart of a method 400 for self-learning ILM. The method 400 begins by the user defining metadata attributes for a particular data type (step 402). The metadata is applied by the policy manager as rules to individual data records having that data type (step 404). Each application of the rule is recorded, along with statistics regarding the rule (step 406). Next, a determination is made whether the rule needs to be revised based on the collected statistics (step 408). The decision to update the rule can be based on a predefined set of thresholds, such as time since the rule was first applied, number of times the rule has been applied, etc. If the rule does not need to be revised, then the method 400 continues by applying rules. If the rule needs to be revised, then the rule is revised and any metadata associated with the rule is updated as needed (step 410). As noted above, this can include expanding or contracting metadata levels for a particular attribute.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A system for information life-cycle management, comprising:
a metadata depicter, configured to create metadata for an attribute of a data type, the metadata including at least one level;
a policy manager, configured to apply the metadata as a rule to data records of the data type;
a data manager, configured to control at least one data storage device, said data manager operating under direction of said policy manager; and
a data organizer, configured to determine how data is organized on said at least one data storage device, said data organizer operating under direction of said policy manager.

2. The system according to claim 1, wherein said policy manager includes:
a policy driver, configured to apply the rule;
a statistics collector, configured to collect statistics about the applied rule; and
a metadata classifier, configured to determine whether the rule needs to be revised based on the collected statistics.

3. The system according to claim 2, wherein said metadata classifier is further configured to define additional metadata levels for a particular attribute.

4. The system according to claim 1, further comprising a data synchronizer configured to obtain data records and to synchronize data records between a source device and said at least one storage device.

5. The system according to claim 1, further comprising a retrieval engine configured to retrieve data records from said at least one storage device.

6. The system according to claim 1, further comprising a security handler configured to control access to data records.

7. The system according to claim 1, further comprising a backup handler configured to create backups of data records and to move data between different levels of a data storage hierarchy.

8. The system according to claim 1, further comprising a user interface configured to permit a user to enter metadata attributes for a data type, said metadata depicter using the entered metadata attributes.

9. A self-learning policy manager for use in a information life-cycle management system, the policy manager comprising:
a policy driver, configured to apply a rule to a data record based on predefined metadata;
a statistics collector, configured to collect statistics about the applied rule; and
a metadata classifier, configured to determine whether the rule needs to be revised based on the collected statistics.

10. A method for information life-cycle management, comprising the steps of:
defining metadata attributes for a data type;
creating a rule based on the metadata attributes;
applying the rule to data records;
recording application of the rule;
collecting statistics about the application of the rule;
determining whether the rule needs to be revised based on the collected statistics; and
revising the rule if needed and updating metadata associated with the rule.
